(19) United States
(12) Patent Application Publication
(10) Pub. No.: US 2024/0233567 A1
(43) Pub. Date: Jul. 11, 2024

(54) SYSTEM, METHOD, AND COMPUTER READABLE MEDIUM FOR DEVELOPING PROFICIENCY OF A USER IN A TOPIC

(71) Applicant: Headway Innovation, Inc., New Rochelle, NY (US)

(72) Inventors: Alexander Sergeevich Yuryev, Shenzhen (CN); Valeriy Timofeevich Skubeev, Chita (RU)

(73) Assignee: Headway Innovation, Inc., New Rochelle, NY (US)

(21) Appl. No.: 16/318,125

(22) PCT Filed: Jan. 13, 2019
(86) PCT No.: PCT/US19/13407

§ 371 Date: Sep. 2, 2021

(51) Int. Cl. G09B 7/02

(52) U.S. Cl. CPC G09B 7/02

(57) ABSTRACT

A system is configured to store instructions that are executable by one or more processors to perform computing platform for developing, via non-linear learning, a desired proficiency of a user in a topic. A server is communicatively coupled to a network and including a processor, an adoptive information potential (AIP) module, a database containing portions allocated to at least congnigraphics data and non-cognigraphics data, and at least one non-transitory computer-readable storage medium having computer-readable instructions stored therein. The processor executes the computer-readable instructions to receive input from the user based on a set of one or more questions prompted by the platform, the set of one or more questions comprising congnigraphics data and non-cognigraphics data. A continuous check and update of a user profile is performed based on a set of one or more conditions, in response to completion by the user the one or more variable AIP learning scenarios of the first level, provide to the user an exit scenario test, and iteratively execute the one or more levels of the AIP learning to attain a desired proficiency of the user in the topic.

### FIELD OF THE INVENTION

The present invention relates to system, method, and computer-readable medium used by teachers to enable student learning of various disciplines and to gain skills and configured to store instructions that are executable by one or more processors to perform developing a desired proficiency of a user in a topic.

### BRIEF DESCRIPTION OF THE INVENTION

Typical, educational system includes the textbooks, the curricula, the classrooms, and the schedules students follow. This education system hasn't changed much over the centuries. To this day, the students receive mass-produced content that was designed around standardized tests. It is important to mention that these tests do not accommodate individual learning needs. The content has to be delivered in a very particular way, i.e. in a linear format. Let's say that the entire education path presents a plurality of Units, i.e. Unit 1, Unit 2, and so on, whereby the students are not supposed to proceed to Unit 2 until they learned Unit 1. Nor will the students will understand Unit 3 until the students have learned Unit 2, and so on.

Another approach of education is called a non-linear learning. On one level, non-linear learning is the way that people naturally learned for a couple of hundred thousand years. For example, people didn't learn to fish or hunt in a linear way—through a staggered, textbook process. Instead, people learned to do these tasks by doing, through direct experience and dealing with things as they arose. People also learned how to fish or hunt or other skills through discovering what was important at that particular time and through making connections between stuff people already knew and didn't know by actively constructed the knowledge as people needed it. It was all very subjective and individual and not linear.

Alluding to the above, human brains are designed to work/learn this way, but it is a subjective process because each individual experience distinct social and psychological phenomenon. As is was perfectly presented by some scholars “It is not an objective one size fit, but an experience that is entirely unique . . . learning in the natural environment was not linear. There is a level on which it was actually quite random. It was situational”.

Today, life skills, such as career and retirement planning, are often not in the curriculum of formal educational institutions. However, it is particularly important to teach such skills to teenagers who have not yet started their careers, and adults who have started their careers, but face many obstacles and decisions that have to be made regarding their career paths and retirement plans. Further, many individuals, once they begin their careers, are not prepared for the experiences they will encounter along the way, such as experiences with supervisors, also known as bosses.

A teaching method comprises the principles and methods used by teachers to enable student learning. These strategies are determined partly on subject matter to be taught and partly by the nature of the learner. For a particular teaching method to be appropriate and efficient it has to be in relation with the characteristic of the learner and the type of learning it is supposed to bring about. Suggestions are there to design and selection of teaching methods must take into account not only the nature of the subject matter but also how students learn. In today's school the trend is that it encourages a lot of creativity. It is a known fact that human advancement comes through reasoning. This reasoning and original thought enhances creativity.

The approaches for teaching can be broadly classified into teacher centered and student centered. In teacher-centered approach to learning, teachers are the main authority figure in this model. Students are viewed as “empty vessels” whose primary role is to passively receive information (via lectures and direct instruction) with an end goal of testing and assessment. It is the primary role of teachers to pass knowledge and information onto their students. In this model, teaching and assessment are viewed as two separate entities. Student learning is measured through objectively scored tests and assessments.

In student-centered approach to learning, while teachers are the authority figure in this model, teachers and students play an equally active role in the learning process. The teacher's primary role is to coach and facilitate student learning and overall comprehension of material. Student learning is measured through both formal and informal forms of assessment, including group projects, student portfolios, and class participation. Teaching and assessments are connected; student learning is continuously measured during teacher instruction. Commonly used teaching methods may include class participation, demonstration, recitation, memorization, or combinations of these.

Referring now to an adaptive learning, it is important to say that it is a sophisticated, data-driven, and in some cases, nonlinear approach to instruction and remediation, adjusting to a learner's interactions and demonstrated performance level, and subsequently anticipating what types of content and resources learners need at a specific point in time to make progress.

Adaptive learning has the potential to transform student learning by providing students with self-paced individualized learning experiences. Adaptive learning can be defined as an approach to creating a personalized learning experience for students. Adaptive learning also takes a sophisticated, data-driven, and in some cases, non-linear approach to instruction and remediation, adjusting to a learner's interactions and demonstrated performance level and subsequently anticipating what types of content and resources learners need at a specific point in time to make progress.

Alluding to the above, active learning occurs when students are no longer just passive participants in the learning process. Active learning can be as simple as students working in groups in the classroom instead of listening to a lecture.

The combination of adaptive and active has been shown to increase student outcomes. These pedagogical approaches provide faculty with data and insight about student performance. As a result, more faculty are changing the tactics they use in the classroom to be active and make sure all students succeed or achieve mastery sooner.

However, prior art systems and methods of teaching have several negatives or drawbacks. All attempts to define skills and what constitutes skills have failed to bring a unified and comprehensive definition or structure of skills in the sense that it applies to all contexts, types of skills, levels, and the like. The current available solutions and methods try to package information and content against “skills” however they vary in size, content size, information covered, etc.

Thus, a particular course in higher education context to teach a skill will vary from one university to another, also it will be different to any of those same “skill” courses offered via trainers, or online training websites.

To the extent as being effective, there is always a need for new and improved systems and methods directed to systems and methods of teaching life skills and/or preparing individuals for life-type experiences. The present invention aims to solve this problem by simple and convenient means.

### SUMMARY OF THE INVENTION

In one embodiment of the present invention, a computing platform or system is provided. The computing platform is used for developing, via non-linear learning, a desired proficiency of a user (a learner) in a topic. The platform includes a server communicatively coupled to a network and includes a processor, an adoptive information potential (AIP) module, a database containing portions allocated to at least congnigraphics data and non-cognigraphics data, and at least one non-transitory computer-readable storage medium having computer-readable instructions stored therein. The processor executes the computer-readable instructions to receive input from the user based on a set of one or more questions prompted by the platform, the set of one or more questions comprising congnigraphics data and non-cognigraphics data.

The processor further executes the computer-readable instructions to construct a user profile based on the congnigraphics and non-cognigraphics data, store the user profile in the database, and generate, based on the user profile, a first AIP recommendation for the user, the first AIP recommendation comprising a first set of one or more courses or training to be taken by the user based on the user profile. Then, the processor executes the computer-readable instructions to execute a first AIP assessment of the user, in response to the user not passing the first AIP assessment, execute a first level of one or more levels of AIP learning and display at least one of one or more variable AIP learning scenarios to the user, wherein the first level is selected according to the user profile including cognitive and non-cognitive attributes and to perform a continuous check and update of the user profile based on a set of one or more conditions. In response to completion by the user the one or more variable AIP learning scenarios of the first level, provide to the user an exit scenario test to advance the user to a second level of the one or more levels of the AIP learning based on the exit scenario test. The processor executes the computer-readable instructions iteratively execute the one or more levels of the AIP learning to attain a desired proficiency of the user in the topic.

In another embodiment of the present invention, a computer readable medium is provided. The computer readable medium for storing code representing instructions that when executed at the processor cause the processor to store instructions to perform developing, via non-linear learning, a desired proficiency of the user in a topic, wherein the server is communicatively coupled to the network and including the processor, the adoptive information potential (AIP) module, the database containing portions allocated to at least congnigraphics data and non-cognigraphics data.

The computer readable medium receives input from the user based on a set of one or more questions prompted by the platform, the set of one or more questions comprising congnigraphics data and non-cognigraphics data and constructs the user profile based on the congnigraphics and non-cognigraphics data. The computer readable medium stores the user profile in the database, generates, based on the user profile, a first AIP recommendation for the user, the first AIP recommendation comprising a first set of one or more courses or training to be taken by the user based on the user profile, and executes a first AIP assessment of the user.

Alluding to the above, in response to the user not passing the first AIP assessment, the computer readable medium executes a first level of one or more levels of AIP learning and display at least one of one or more variable AIP learning scenarios to the user, wherein the first level is selected according to the user profile including cognitive and non-cognitive attributes. The computer readable medium performs a continuous check and update of the user profile based on a set of one or more conditions, and in response to completion by the user the one or more variable AIP learning scenarios of the first level, provides to the user an exit scenario test, thereby advancing the user to a second level of the one or more levels of the AIP learning based on the exit scenario test. The computer readable medium iteratively executes the one or more levels of the AIP learning to attain a desired proficiency of the user in the topic.

In yet another embodiment of the present invention, a method is provided. The method of storing instructions that are executable by one or more processors to perform developing, via non-linear learning, a desired proficiency of a user in a topic, wherein a server is communicatively coupled to a network and including a processor, an adoptive information platform (AIP) module, a database containing portions allocated to at least congnigraphics data and non-cognigraphics data, and at least one non-transitory computer-readable storage medium having computer-readable instructions stored therein. The method comprises the steps of receiving input from the user based on a set of one or more questions prompted by the platform, the set of one or more questions comprising congnigraphics data and non-cognigraphics data and constructing a user profile based on the congnigraphics and non-cognigraphics data.

The method further comprises the steps of storing the user profile in the database and generating, based on the user profile, a first AIP recommendation for the user, the first AIP recommendation comprising a first set of one or more courses or training to be taken by the user based on the user profile. The method further comprises the steps of executing a first AIP assessment of the user, and, in response to the user not passing the first AIP assessment, executing a first level of one or more levels of AIP learning and display at least one of one or more variable AIP learning scenarios to the user, wherein the first level is selected according to the user profile including cognitive and non-cognitive attributes.

The method further comprises the steps of performing a continuous check and update of the user profile based on a set of one or more conditions, and, in response to completion by the user the one or more variable AIP learning scenarios of the first level, providing to the user an exit scenario test. The method further comprises the steps of advancing the user to a second level of the one or more levels of the AIP learning based on the exit scenario test; and iteratively executing the one or more levels of the AIP learning to attain a desired proficiency of the user in the topic.

An advantage of the present invention is to provide innovative system, method, and non-transitory processor-readable medium adaptable to measure and quantify information and knowledge and define skills by breaking them into smaller quantifiable and measurable units thereby creating minimal units of skills, next-gen skills.

Another advantage of the present invention is to provide the innovative system, method, and non-transitory processor-readable medium to allow to adapt and use information in multiple contexts and scenarios after changing and modifying its corresponding restrictions.

Still another advantage of the present invention is to provide the innovative system, method, and non-transitory processor-readable medium to allow actions and skills to be practiced and challenged through scenarios ability to assess learners through AIP assessment.

Still another advantage of the present invention is to provide the innovative system, method, and non-transitory processor-readable medium allow to train learners to learn new skills or improve existing ones by training those AIPs.

Still another advantage of the present invention is provide the innovative system, method, and non-transitory processor-readable medium to provide comprehensive methodology based on the forefront cross-disciplinary studies of cognitive science, learning theories and pedagogies.

Still another advantage of the present invention is to provide the innovative system, method, and non-transitory processor-readable medium for improving learners' cognitive abilities through training in different cognitive levels.

Still another advantage of the present invention is to provide the innovative system, method, and non-transitory processor-readable medium adapting courses to learners' cognitive profile, abilities, and other non-cognitive factors.

Still another advantage of the present invention is to provide the innovative system, method, and non-transitory processor-readable medium presenting a variety of courses to show balance between depth and breadth of courses and information presented.

Still another advantage of the present invention is to provide the innovative system, method, and non-transitory processor-readable medium that will allow speeding up and systematizing knowledge acquisition and information management in organizations.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic block diagram of a computing system hosting an object analysis system, according to an implementation;

FIG. 2 shows a diagram of Registration and AIP recommendation phase of a system for developing, via non-linear learning, a desired proficiency of a user in a topic;

FIG. 3 shows a diagram of AIP Assessment process phase of the system;

FIG. 4 shows a diagram of AIP Learning—Scenarios and Blocks phase of the system;

FIG. 5 shows a diagram of AIP Checks & Non-linear Learning phase of the system; and

FIG. 6 shows a diagram of the entire system for developing, via non-linear learning, a desired proficiency of a user in a topic.

### DETAILED DESCRIPTION OF THE INVENTION

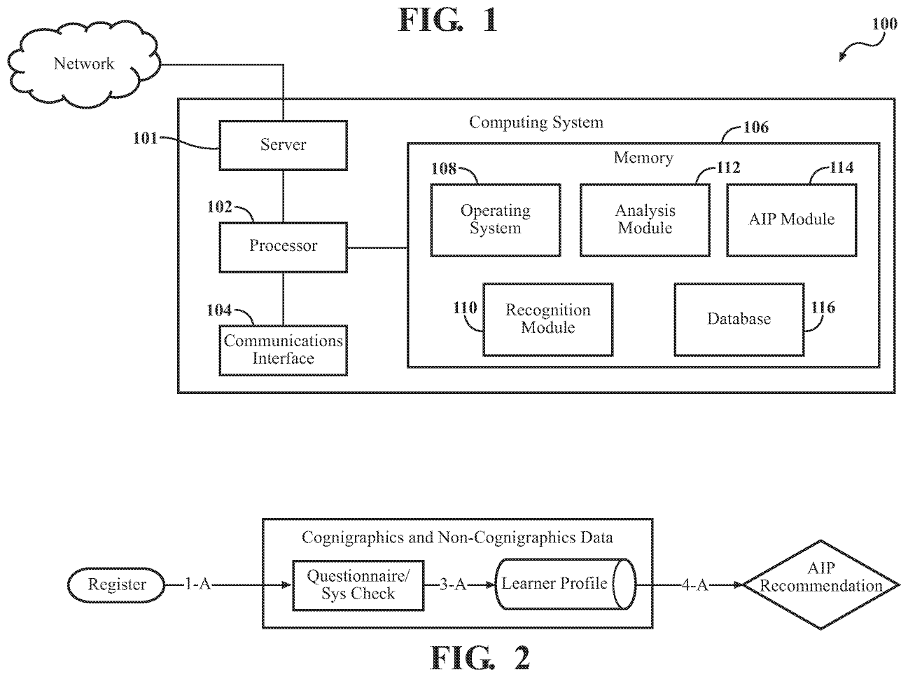

Referring to the FIGS. 1 through 6, a system, a method, and a non-transitory processor-readable medium, i.e. a computer readable medium, for developing, via non-linear learning, a desired proficiency of a user in a topic are shown. Because explicit identification of object-oriented constructs expressed through the syntax of high-level object-oriented programming languages is lost during compilation to binary code (e.g., translation of a source code definition or representation of an application to a binary code definition or representation of the application such as a machine code or byte-code definition), potential security vulnerabilities can be obscured during static analysis of the resulting binary code. For example, because information about an object (e.g., the class on which the object is based, the size of the object, the number and types or sizes of properties of the object, and the number of functionalities accessible to the object via a dispatch table) is typically not expressed in binary code, determining whether indirect operations relative to the object expose security vulnerabilities can be difficult without the source code from which the binary code was generated.

As a specific example, an indirect operation can result in arbitrary code execution security vulnerabilities if the binary code does not include run-time validation to ensure that the indirect operation does not operate outside or beyond the object (i.e., at memory addresses not allocated to or shared by the object). Some binary code representations of applications, however, do include information about objects. Such information can be included in binary code as run-time type information (RTTI) or debugging information that is compiled into the binary code. Nevertheless, because the binary code representations of many applications do not include such information (e.g., to discourage reverse engineering of these applications), robust methodologies and systems for analyzing binary code based on (or derived from) source code using object-oriented techniques should not assume availability of such information.

Implementations discussed herein analyze operations described in binary code to identify objects based on those operations. Said differently, implementations discussed herein reconstruct, at least partially, objects (or representations of objects) by inferring the structure of such objects based on operations described in binary code. Thus, implementations discussed herein can identify objects and attributes such as a size thereof without referring to (or independent of) source code or explicit information about such objects which may or may not be included in the binary code. Furthermore, implementations discussed herein perform security vulnerability analyses of binary code representations of applications using such objects. For example, implementations discussed herein can identify security vulnerabilities such as type confusion vulnerabilities that can result in arbitrary code execution, code injection, application failure, or other undesirable or unintended behavior of an application using information about objects identified by analysis of operations described in binary code.

As used herein, the term “software module” refers to a group of code representing instructions that can be executed at a computing system or processor to perform some functionality. Applications, software libraries (e.g., statically-linked libraries or dynamically-linked libraries), and application frameworks are examples of software modules. Additionally, as used herein, the terms “operations described in binary code” and “operations defined in binary code” and similar terms or phrases refer to operations described by code representing instructions that exist in a binary code representation (or binary representation) of a software module.

In some implementations discussed herein, operations described in binary code are analyzed (e.g., parsed and interpreted) in a representation other than a binary code representation of a software module. For example, an object analysis system can analyze operations described in binary code using an intermediate representation of a software module derived from a binary code representation of that software module.

Accordingly, implementations discussed herein with reference to analysis of operations described in binary code should be understood to refer to analysis of those operations using a binary code representation of a software module or a representation of the software module derived from the binary code representation.

A variable within a memory is a memory location at which one or more values can be stored. Such a memory location can be at a processor memory (e.g., a register or cache), at a system memory (e.g., a Random Access Memory (RAM) of a computing system), or at some other memory. Operations within binary code that operate on such variables can refer to a memory address (either absolute or relative to another memory address such as an offset from a stack pointer) of that memory location. Thus, the identifier (e.g., memory address) of an object can be stored as a value at a memory location with a memory address that is used by operations within the binary code.

Accordingly, as used herein, terms such as “identifier of an object” and “memory address of an object” should be understood to refer to the identifier (e.g., memory address) itself or to a variable at which a value representing the identifier is stored. As used herein, the term “module” refers to a combination of hardware (e.g., a processor such as an integrated circuit or other circuitry) and software (e.g., machine- or processor-executable instructions, commands, or code such as firmware, programming, or object code).

A combination of hardware and software includes hardware only (i.e., a hardware element with no software elements), software hosted at hardware (e.g., software that is stored at a memory and executed or interpreted at a processor), or at hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

FIG. 1 is a schematic block diagram of a computing system or platform, generally shown at 100, hosting an object analysis system, according to an implementation. The computing system 100 includes processor 102, a communications interface 104, and a memory 106, and a hosts operating system 108, a recognition module 110, an analysis module 112, and Adaptive Information Potential (AIP) module 114. The processor 102 is any combination of hardware and software that executes or interprets instructions, codes, or signals. For example, the processor 102 can be a microprocessor, an application-specific integrated circuit (ASIC), a distributed processor such as a cluster or network of processors or computing systems, a multi-core or multi-processor processor, or a virtual or logical processor of a virtual machine.

The communications interface 104 is a module via which the processor 102 can communicate with other processors or computing systems via communications link. For example, the computing system 100 can report security vulnerabilities to an electronic mailbox or instant messaging service via a communications link using the communications interface 104. For example, communications interface 104 can include a network interface card and a communications protocol stack hosted at processor 510 (e.g., instructions or code stored at memory 106 and executed or interpreted at the processor 102 to implement a network protocol).

As specific examples, the communications interface 104 can be a wired interface, a wireless interface, an Ethernet interface, a Fiber Channel interface, an InfiniBand interface, or some other communications interface via which the processor 102 can exchange signals or symbols representing data to communicate with other processors or computing systems. The memory 106 is a processor-readable medium that stores instructions, codes, data, or other information. As used herein, a processor-readable medium is any medium that stores instructions, codes, data, or other information non-transitorily and is directly or indirectly accessible to a processor.

Said differently, a processor-readable medium is a non-transitory medium at which a processor can access instructions, codes, data, or other information. For example, the memory 106 can be a volatile random access memory (RAM), a persistent data store such as a hard disk drive or a solid-state drive, a compact disc (CD), a digital video disc (DVD), a Secure Digital™ (SD) card, a MultiMediaCard (MMC) card, a CompactFlash™ (CF) card, or a combination thereof or other memories. Said differently, the memory 106 can represented multiple processor-readable media. In some implementations, the memory 106 can be integrated with the processor 102, separate from the processor 102, or external to the computing system 100.

Alluding to the above, the memory 106 includes instructions or codes that when executed at the processor 102 implement the operating system 108, the recognition module 104, and the analysis module 112. In other words, operating system 108 and an object analysis system including the recognition module 110, and the analysis module 112 are hosted at the computing system 100. In some implementations, the computing system 100 can be a virtualized computing system. For example, the computing system 100 can be hosted as a virtual machine at a computing server.

Moreover, in some implementations, the computing system 100 can be a virtualized computing appliance, and the operating system 108 is a minimal or just-enough operating system to support (e.g., provide services such as a communications protocol stack and access to components of the computing system 100 such as the communications interface 104, the recognition module 110 and the analysis module 112. The recognition module 110 and the analysis module 112 can be accessed or installed at the computing system 100 from a variety of memories or processor-readable media.

For example, the computing system 100 can access the recognition module 110 and the analysis module 112 at a remote processor-readable medium via the communications interface 104. As another example, the computing system 100 can include (not illustrated in FIG. 1) a processor-readable medium access device (e.g., CD, DVD, SD, MMC, or a CF drive or reader), and can access the recognition module 110 and the analysis module 112 at a processor-readable medium via that processor-readable medium access device.

As a more specific example, the processor-readable medium access device can be a DVD drive at which a DVD including an installation package for one or more of the recognition module 110 and the analysis module 112 is accessible. The installation package can be executed or interpreted at the processor 102 to install one or more of the recognition module 110 and analysis module 112 at computing system 100 (e.g., at memory). The computing system 100 can then host or execute the recognition module 110 and the analysis module 112. In some implementations, the recognition module 110 and the analysis module 112 can be accessed at or installed from multiple sources, locations, or resources. For example, some components of the recognition module 110 and the analysis module 112 can be installed via a communications link, and other components of the recognition module 110 and the analysis module 112 can be installed from a DVD.

The computing platform 100 of the present invention is used for developing, via non-linear learning, a desired proficiency of a user in a topic. The platform 100 includes the server 101 communicatively coupled to a network and including the processor, the adoptive information potential (AIP) module 114, the database 116 containing portions allocated to at least congnigraphics data and non-cognigraphics data, and at least one non-transitory computer-readable storage medium having computer-readable instructions stored therein.

The processor 102 executes the computer-readable instructions to receive input from the user based on a set of one or more questions prompted by the platform 100, the set of one or more questions comprising congnigraphics data and non-cognigraphics data. The processor 102 further executes the computer-readable instructions to construct a user profile based on the congnigraphics and non-cognigraphics data, store the user profile in the database 116, and generate, based on the user profile, a first AIP recommendation for the user, the first AIP recommendation comprising a first set of one or more courses or training to be taken by the user based on the user profile.

Alluding to the above, the processor 102 executes the computer-readable instructions to execute a first AIP assessment of the user, in response to the user not passing the first AIP assessment, execute a first level of one or more levels of AIP learning and display at least one of one or more variable AIP learning scenarios to the user, wherein the first level is selected according to the user profile including cognitive and non-cognitive attributes and to perform a continuous check and update of the user profile based on a set of one or more conditions.

In response to completion by the user the one or more variable AIP learning scenarios of the first level, provide to the user an exit scenario test to advance the user to a second level of the one or more levels of the AIP learning based on the exit scenario test. The processor 102 executes the computer-readable instructions iteratively execute the one or more levels of the AIP learning to attain a desired proficiency of the user in the topic.

Each of the one or more variable learning scenarios comprises logical chains of learning blocks positioned according to a learning pattern of the user, and wherein the one or more variable AIP learning scenarios are matched to one or more interests of the user corresponding to the topic. The learning blocks comprise at least one input block and one output block connected together. The learning blocks comprise an input content and an output content, wherein the input content includes text, audio, video, or images, and wherein the output items include interaction of the user with the input content.

The set of the one or more conditions comprises at least one of: time spent in each AIP learning scenario or in a session, response speed of the user or speed of the user in completing a task or an objective of each AIP learning scenario, number of attempts by the user to complete the task or the objective, absolute or relative correct answer score, demographics, location of the user, computing device of the user, connection speed of the user, or weather conditions of the location of the user. The continuous check comprises (1) a continuous check of the set of the one or more conditions, and (2) a full AIP assessment.

The processor 102, in response to the user passing the full AIP assessment, is configured to cause the user to exit the AIP learning. The processor 102, in response to the user failing the full AIP assessment, is configured to redirect the user to (1) the at least one of the one or more variable AIP learning scenarios, or (2) one of the one or more levels of the AIP learning. The processor 102, in response to the user passing the first AIP assessment, is configured to cause the user to exit the AIP learning.

The computer readable medium for storing code representing instructions that when executed at the processor 102 cause the processor 102 to store instructions to perform developing, via non-linear learning, a desired proficiency of a user in a topic, wherein the server 101 is communicatively coupled to the network and including the processor 102, the adoptive information potential (AIP) module 114, the database 116 containing portions allocated to at least congnigraphics data and non-cognigraphics data. The computer readable medium receives input from the user based on a set of one or more questions prompted by the platform 100, the set of one or more questions comprising congnigraphics data and non-cognigraphics data and constructs a user profile based on the congnigraphics and non-cognigraphics data.

The adoptive information potential (AIP) module generates a plurality of first identifiers A1, A2, A3, A4, . . . . An are assigned to each subject area section or domain topically designed and established to separate specific concentrations and areas of study within the group as per the theme or the topic of study, and the function. The adoptive information potential (AIP) module 114 divides each of the subject area sections into respective sub-levels, wherein each reflects a skill element such as specification and specialization of the respective subject area. The adoptive information potential (AIP) module 114 generates a plurality of second identifiers such as B1, B 2, B 3, B 4, . . . Bn are assigned to each skill element, wherein each skill element represents the ability to adequately perform, execute, and apply a specific number of potentials that can be functionally, topically or thematically linked and grouped together. Each sub-level reflects multiple skill elements.

The adoptive information potential (AIP) module 114 generates a plurality of third identifiers C1, C2, C 3, C 4, . . . Cn are assigned to each of the skill element 20, wherein each of the third identifiers C1, C2, C 3, C 4, . . . Cn indicates at least one of the respective skill level, type, and category. A list of criterial elements 30 correlated to list of skill demands, is separated by a plurality of fourth identifiers D1, D2, D3, D4, . . . Dn.

The adoptive information potential (AIP) module 114 generates a plurality of scenarios including series or logical chains of learning blocks will be checked to make sure that they are fitting exactly according to how the learner learns while checking cognigraphic profile of the learner in order to adapt to any change and redirect them to different level or scenario. The method allows to determine and track relationship and correlation between the plurality of the first identifiers A1, A2, A3, A4, . . . An, the second identifiers B1, B 2, B 3, B 4, . . . Bn, the third C1, C2, C 3, C 4, . . . Cn in order to relate the final result to match with the plurality of fourth identifiers D1, D2, D3, D4, . . . Dn if the skill is learned in response comprehensive questions and tests of from different scenarios and levels thereby evaluating whether the learner has successfully completed the scenarios and completed the training.

The computer readable medium stores the user profile in the database 116, generates, based on the user profile, a first AIP recommendation for the user, the first AIP recommendation comprising a first set of one or more courses or training to be taken by the user based on the user profile, and executes a first AIP assessment of the user. In response to the user not passing the first AIP assessment, the computer readable medium executes a first level of one or more levels of AIP learning and display at least one of one or more variable AIP learning scenarios to the user, wherein the first level is selected according to the user profile including cognitive and non-cognitive attributes.

The computer readable medium performs a continuous check and update of the user profile based on a set of one or more conditions, and in response to completion by the user the one or more variable AIP learning scenarios of the first level, provides to the user an exit scenario test, thereby advancing the user to a second level of the one or more levels of the AIP learning based on the exit scenario test. The computer readable medium iteratively executes the one or more levels of the AIP learning to attain a desired proficiency of the user in the topic.

In response to the user not passing the first AIP assessment, executing the first level of one or more levels of AIP learning and display at least one of one or more variable AIP learning scenarios each of the one or more variable AIP learning scenarios comprises logical chains of learning blocks positioned according to a learning pattern of the user, and wherein the one or more variable AIP learning scenarios are matched to one or more interests of the user corresponding to the topic. The computer readable medium is adaptable to present the learning blocks comprising at least one input block and one output block connected together.

The computer readable medium is adaptable to present the learning blocks including an input content and an output content, wherein the input content includes text, audio, video, or images, and wherein the output items include interaction of the user with the input content. The computer readable medium is adaptable to present the set of the one or more conditions comprises at least one of: time spent in each AIP learning scenario or in a session, response speed of the user or speed of the user in completing a task or an objective of each AIP learning scenario, number of attempts by the user to complete the task or the objective, absolute or relative correct answer score, demographics, location of the user, computing device of the user, connection speed of the user, or weather conditions of the location of the user.

The computer readable medium is adaptable to present check comprising (1) a continuous check of the set of the one or more conditions, and (2) a full AIP assessment. The computer readable medium is configured to communicate with the processor, in response to the user passing the full AIP assessment, and configured to cause the user to exit the AIP learning. The computer readable medium is configured to receive the response to the user failing the full AIP assessment, and configured to redirect the user to (1) the at least one of the one or more variable AIP learning scenarios, or (2) one of the one or more levels of the AIP learning, wherein the processor, in response to the user passing the first AIP assessment, is configured to cause the user to exit the AIP learning.

A method of storing instructions that are executable by one or more processors to perform developing, via non-linear learning, a desired proficiency of a user in a topic, wherein the server 101 is communicatively coupled to the network and including the processor 102, the adoptive information platform (AIP) module 114, the database 116 containing portions allocated to at least congnigraphics data and non-cognigraphics data, and at least one non-transitory computer-readable storage medium having computer-readable instructions stored therein. The method comprises the steps of receiving input from the user based on a set of one or more questions prompted by the platform 100, the set of one or more questions comprising congnigraphics data and non-cognigraphics data and constructing the user profile based on the congnigraphics and non-cognigraphics data.

The method further comprises the steps of storing the user profile in the database 116 and generating, based on the user profile, a first AIP recommendation for the user, the first AIP recommendation comprising a first set of one or more courses or training to be taken by the user based on the user profile. The method further comprises the steps of executing a first AIP assessment of the user, and, in response to the user not passing the first AIP assessment, executing a first level of one or more levels of AIP learning and display at least one of one or more variable AIP learning scenarios to the user, wherein the first level is selected according to the user profile including cognitive and non-cognitive attributes.

The method further comprises the steps of performing a continuous check and update of the user profile based on a set of one or more conditions, and, in response to completion by the user the one or more variable AIP learning scenarios of the first level, providing to the user an exit scenario test. The method further comprises the steps of advancing the user to a second level of the one or more levels of the AIP learning based on the exit scenario test; and iteratively executing the one or more levels of the AIP learning to attain a desired proficiency of the user in the topic. In response to the user not passing the first AIP assessment, executing the first level of one or more levels of AIP learning and display at least one of one or more variable AIP learning scenarios each of the one or more variable AIP learning scenarios comprises logical chains of learning blocks positioned according to a learning pattern of the user, and wherein the one or more variable AIP learning scenarios are matched to one or more interests of the user corresponding to the topic. The method is adaptable to present the learning blocks comprising at least one input block and one output block connected together. The method is adaptable to present the learning blocks including an input content and an output content, wherein the input content includes text, audio, video, or images, and wherein the output items include interaction of the user with the input content.

The method is adaptable to present the set of the one or more conditions comprises at least one of: time spent in each AIP learning scenario or in a session, response speed of the user or speed of the user in completing a task or an objective of each AIP learning scenario, number of attempts by the user to complete the task or the objective, absolute or relative correct answer score, demographics, location of the user, computing device of the user, connection speed of the user, or weather conditions of the location of the user.

The method is adaptable to present check comprising (1) a continuous check of the set of the one or more conditions, and (2) a full AIP assessment. The method includes the step of configuring to communicate with the processor 102, in response to the user passing the full AIP assessment, and configured to cause the user to exit the AIP learning. The method includes the step of receiving the response to the user failing the full AIP assessment, and configured to redirect the user to (1) the at least one of the one or more variable AIP learning scenarios, or (2) one of the one or more levels of the AIP learning, wherein the processor, in response to the user passing the first AIP assessment, is configured to cause the user to exit the AIP learning.

FIG. 2 shows a registration and AIP recommendation phase, wherein “COGNIGRAPHICS” means a coined word (cognitive+graphics) and refers to information about user's cognitive and learning abilities, preferences, intelligences, and styles. This cognigraphic data contributes and is added to learner profile. “NON-COGNIGRAPHICS”means any information about learner that is NOT related to his learning or cognitive information (cognigraphics). This data includes demographics (age, gender, location, etc.) and other information like preferences, political views, religious views, etc. “QUESTIONNAIRE” means one of the tools and methods of collecting cognigraphic and non-cognigraphic data. The questionnaire takes the format of series of short questions where the learner is asked to rate or select statements that best describe them. “LEARNER PROFILE” is a collection of data and information about the learner that include personal, demographic, cognigraphics and other non cognigraphics data. The profile is frequently updated through different tools to keep it as relevant and reflective of the learner as possible. AIP Single action means ability to adapt information in multiple contexts and scenarios after changing and modifying its corresponding restrictions that MUST have only TWO options: “can do”, or, “cannot do”, with no gradable performance measurement. Registration: the user signs up, as shown at 1, as shown at 1-A, the user is taken to LEARNER PROFILE for creating Learner Profile, as shown at 2.

As shown at 3, the user input data and answer questionnaires and questions to build/update his profile: the questionnaire or survey is scientifically designed to collect important data of the learners in order to know them more. The more accurate and precise the data of the learner profile, the more personalized and effective the learning will be. The types of data that comprise the learner profile are of two types, i.e. cognigraphic data and non-cognigraphic data. This data set is about the characteristics and attributes of the learners when it comes to their cognitive abilities, capacities and strengths.

Some learners might be possessing a specific type of intelligence or maybe they have a specific mind style. The cognigraphic data in the learner's profile stores all these important details and will ensure that the learning content that the learner is going to get is matching these preferences and characteristics. This data is usually collected and updated by answering some questionnaires or answering some questions to unveil the cognitive details of the learners. Non-cognigraphic data is data set is related to all other non-cognitive data that we need in order to make the learning personalized for each learner. The data includes, and not limited to: interests, hobbies, location, gender, race, political views, etc. This data set is important also as it is going to inform the content and the scenarios the learner is going to get exposed to and encounter while they are learning. The concept is that the more the content is matching the learner's interests and environment, the more effective the learning is. The learner profile is the starting point of the learning process. It informs the learning content's type, nature, form, speed, and many other attributes of the content given to each learner.

While the learners start with the content that is aligned and matching to their learning profile through the matching levels, as shown in FIG. 2, they will gradually receive different content from other different levels in order to train them on developing other cognitive abilities, intelligences, and aspects other than the ones matching their profile in order to let them acquire new cognitive abilities. As shown at 3-A, the data is stored in database as the learner profile: this data will be updated periodically and at some specified events such as log-in, finishing training, etc.

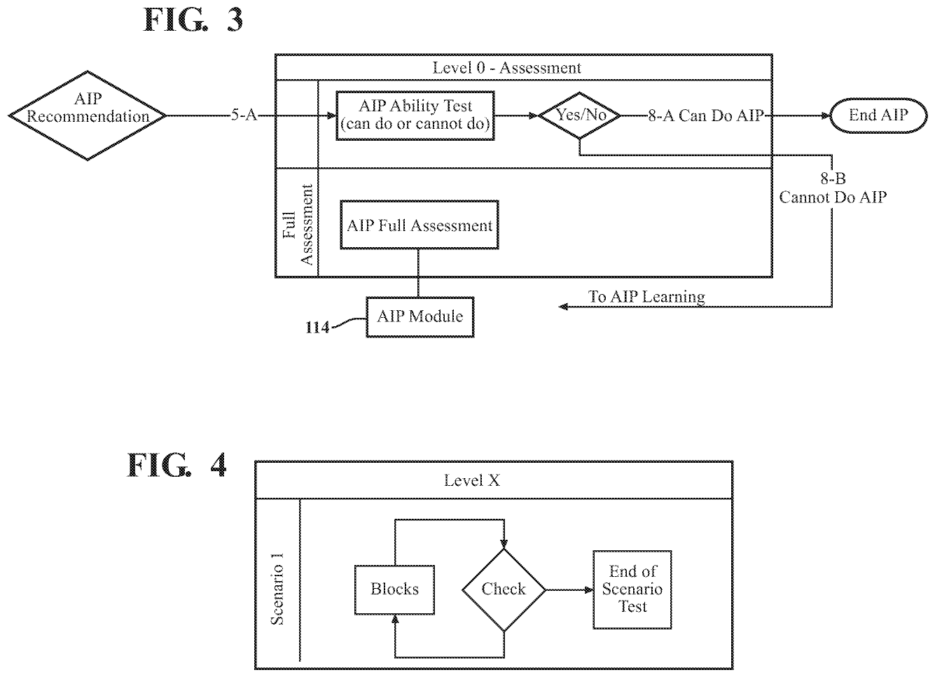

FIG. 3 shows AIP Assessment process phase. AIP Ability Test Series of questions to determine if the learner can perform/has already mastered the AIP, END AIP Learner exiting AIP assessment or learning. AIP is chosen, and the user is taken to assessment, as shown at 6. AIP Ability test: can do or cannot do. The assessment is meant to test whether the learner is already mastering this AIP or not, as shown at 7. When taking the AIP ability test, as shown at 8 and further as shown at 8-A, IF Pass, exit AIP, go to 16: When a learner passes the AIP ability test, it means that they are able to execute it and there is no need for them to take the training of that particular AIP. As shown at 8-B, IF Fail, go to 9. When the learner fails, then they are taken to the AIP learning.

FIG. 4 shows a AIP Learning—Scenarios and Blocks phase. Levels are the distinguished learner cognigraphic data and information that inform the level choice, content nature, content type, and delivery. There are many different levels. Each level is a cognitive ability OR trait OR capacity OR intelligence type. Scenarios are series or logical chains of learning blocks fitting exactly according to how the learner learns that connect input blocks and output blocks together. Content items and screens that have input of information such as texts, audio, video, images, etc., and output where the learners interact with content by answering questions or responding to prompts.

Constant checks of cognigraphics of the learner (learner profile) in order to adapt to any change and redirect them to different level or scenario. Series of blocks and questions to check if the learner has completed the scenario successfully. Set of variables that is checked by the system to detect any change in variables, and redirect learner to update the learner profile accordingly, as shown at 9. The system 100 will take the learner as per their learning profile to the respective LEVEL, here is level X. The learner profile (point #3) will inform and affect which level the learner is going to start the training at. The learning profile has the cognitive and non-cognitive attributes. So, if the learner's profile is marked as musical-rhythmic intelligent, the training will start in that level, as shown at 10.

Alluding to the above, each AIP has unlimited number of scenarios as they represent how the AIP is being executed and performing a potential (AIP's action) can change from one context to another. For example, the AIP “Design Recruiting Status Report” for Recruiters in IT industry will have different scenario from those who are recruiters in Education industry, or it can be offered in project-based learning in one scenario, and in scaffolding in another, yet it is the same AIP. Moreover, scenarios can reflect and be matching the learners' interests. For example, the learners who have interests in cars and engines, will be trained in scenarios that has relation to cars and engines content for example.

The learner starts scenario learning with a series of blocks (input and output) that has specifically designed slides and screens that shows input information, like text and videos, and other output slides and screens such as activities and tasks. There is a set of conditions, as shown at 11, that the system 100 will be checking frequently and automatically to detect any change in variable, and hence, update the learner profile. These checks will include the following conditions: Time spent in current scenario, AIP, session, on platform, etc. Response speed and how fast the learner is completing the tasks and activities, such as number of attempts by the learner per activity or task, correct answers score (absolute/relative), demographics, location of the learner, device being used by the learner, connection speed, and weather at the learner's location. Based on the response from testing these conditions automatically, the learner might be redirected to update their learner profile, and eventually be redirected to a different level, scenario, or taken to a test, etc. When scenario training finishes, as shown at 12, the learners take exit scenario test to determine completing the scenario. The exit scenario text is a summative way to measure their completion or mastering of this particular AIP element or topic in this particular scenario.

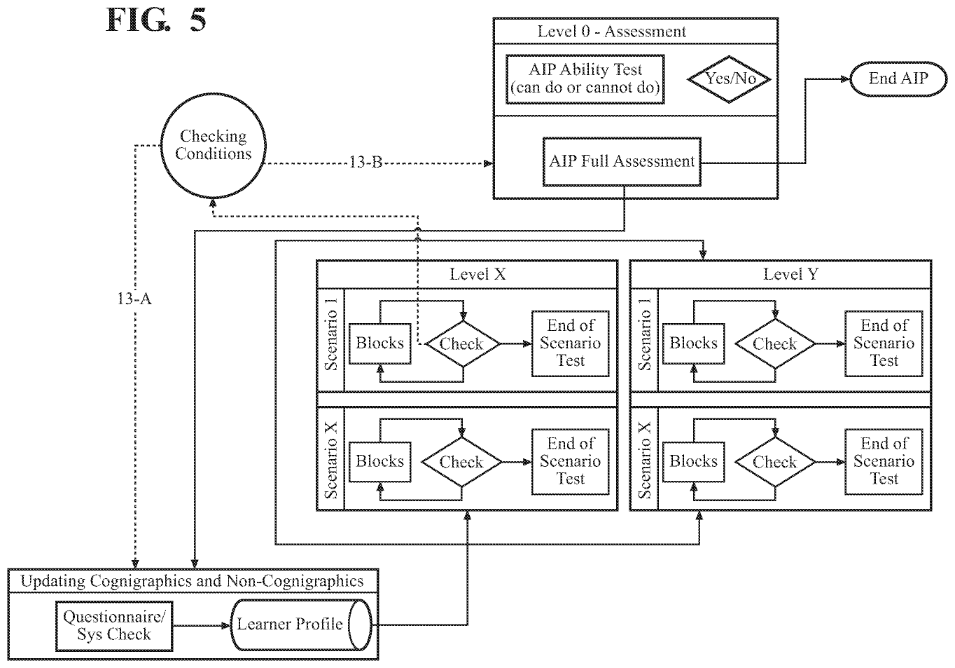

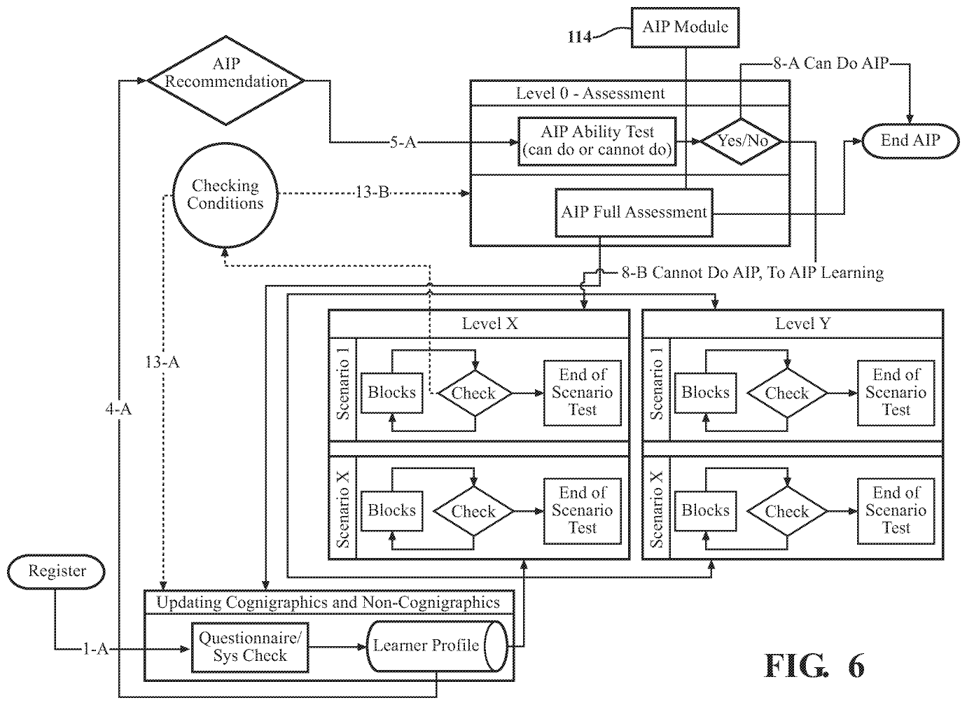

FIG. 5 shows AIP Checks & Non-linear Learning phase. Here, series of questions, tests, and activities to test the progress and attainment of learner in relation to the AIP they are studying. The assessment is comprised of different activities and tests from all levels and scenarios available. Continuous checking process: Involves two checks: as shown at 13-A Continuous check of conditions, if there's a change, systems takes learner to #3. As shown at 13-B, Assessment of AIP (full assessment). If it is completed successfully and learner passes, then the learner is ready to exit the AIP training. If fail, system will check learner profile and may redirect learner to another scenario (14), or level (15). If there is no change in learner profile and data (cognigraphics and non-cognigraphic data), learners will repeat the same scenario.

The system will take learners to train on a different scenario in same level as per the check result. Learners will get the chance to get trained on all possible scenarios available of that AIP in that particular level. Then the process of continuous checking, as shown at 13, and redirecting to other scenario, as shown at 14, is continuous. The system will take learners to different level as per the following: continuous checking of (13) result. When the learner finishes one level, they are taken to another level (15) in order to train their other weak cognitive capacities or abilities. Then the process is continued as per (13) and (14) to check “AIP Full Assessment” if pass, exit and finish AIP training, OR “AIP Full Assessment” if fail, learner is redirected to other scenarios in AIP while the continuous checking of changes of learner's profile (cognigraphics and non-cognigraphics) will take place.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A computing platform for developing, via non-linear learning, a desired proficiency of a user in a topic, the computing platform comprising:
a server communicatively coupled to a network and including a processor, an adoptive information potential (AIP) module, a database containing portions allocated to at least congnigraphics data and non-cognigraphics data, and at least one non-transitory computer-readable storage medium having computer-readable instructions stored therein, wherein the processor executes the computer-readable instructions to:
receive input from the user based on a set of one or more questions prompted by the platform, the set of one or more questions comprising congnigraphics data and non-cognigraphics data;
construct a user profile based on the congnigraphics and non-cognigraphics data;
store the user profile in the database;
generate, based on the user profile, a first AIP recommendation for the user, the first AIP recommendation comprising a first set of one or more courses or training to be taken by the user based on the user profile;
execute a first AIP assessment of the user;
in response to the user not passing the first AIP assessment, execute a first level of one or more levels of AIP learning and display at least one of one or more variable AIP learning scenarios to the user, wherein the first level is selected according to the user profile including cognitive and non-cognitive attributes;
perform a continuous check and update of the user profile based on a set of one or more conditions;
in response to completion by the user the one or more variable AIP learning scenarios of the first level, provide to the user an exit scenario test;
advance the user to a second level of the one or more levels of the AIP learning based on the exit scenario test; and
iteratively execute the one or more levels of the AIP learning to attain a desired proficiency of the user in the topic.

2. The computing platform of claim 1, wherein each of the one or more variable learning scenarios comprises logical chains of learning blocks positioned according to a learning pattern of the user, and wherein the one or more variable AIP learning scenarios are matched to one or more interests of the user corresponding to the topic.

3. The computing platform of claim 2, wherein the learning blocks comprise at least one input block and one output block connected together.

4. The computing platform of claim 3, wherein the learning blocks comprise an input content and an output content, wherein the input content includes text, audio, video, or images, and wherein the output items include interaction of the user with the input content.

5. The computing platform of claim 1, wherein the set of the one or more conditions comprises at least one of: time spent in each AIP learning scenario or in a session, response speed of the user or speed of the user in completing a task or an objective of each AIP learning scenario, number of attempts by the user to complete the task or the objective, absolute or relative correct answer score, demographics, location of the user, computing device of the user, connection speed of the user, or weather conditions of the location of the user.

6. The computing platform of claim 1, wherein the continuous check comprises (1) a continuous check of the set of the one or more conditions, and (2) a full AIP assessment.

7. The computing platform of claim 6, wherein the processor, in response to the user passing the full AIP assessment, is configured to cause the user to exit the AIP learning.

8. The computing platform of claim 6, wherein the processor, in response to the user failing the full AIP assessment, is configured to redirect the user to (1) the at least one of the one or more variable AIP learning scenarios, or (2) one of the one or more levels of the AIP learning.

9. The computing platform of claim 1, wherein the processor, in response to the user passing the first AIP assessment, is configured to cause the user to exit the AIP learning.

10. A computer readable medium storing code representing instructions that when executed at a processor cause the processor to store instructions to perform developing, via non-linear learning, a desired proficiency of a user in a topic, wherein a server is communicatively coupled to a network and including the processor, an adoptive information potential (AIP) module, a database containing portions allocated to at least congnigraphics data and non-cognigraphics data, comprising:
receiving input from the user based on a set of one or more questions prompted by the platform, the set of one or more questions comprising congnigraphics data and non-cognigraphics data;
constructing a user profile based on the congnigraphics and non-cognigraphics data;
storing the user profile in the database;
generating, based on the user profile, a first AIP recommendation for the user, the first AIP recommendation comprising a first set of one or more courses or training to be taken by the user based on the user profile;
executing a first AIP assessment of the user;
in response to the user not passing the first AIP assessment, executing a first level of one or more levels of AIP learning and display at least one of one or more variable AIP learning scenarios to the user, wherein the first level is selected according to the user profile including cognitive and non-cognitive attributes;
performing a continuous check and update of the user profile based on a set of one or more conditions;
in response to completion by the user the one or more variable AIP learning scenarios of the first level, providing to the user an exit scenario test;
advancing the user to a second level of the one or more levels of the AIP learning based on the exit scenario test; and
iteratively executing the one or more levels of the AIP learning to attain a desired proficiency of the user in the topic.

11. The computer readable medium of claim 10, wherein in response to the user not passing the first AIP assessment, executing the first level of one or more levels of AIP learning and display at least one of one or more variable AIP learning scenarios each of the one or more variable AIP learning scenarios comprises logical chains of learning blocks positioned according to a learning pattern of the user, and wherein the one or more variable AIP learning scenarios are matched to one or more interests of the user corresponding to the topic.

12. The computer readable medium of claim 11, adaptable to present the learning blocks comprising at least one input block and one output block connected together.

13. The computer readable medium of claim 12, adaptable to present the learning blocks including an input content and an output content, wherein the input content includes text, audio, video, or images, and wherein the output items include interaction of the user with the input content.

14. The computer readable medium of claim 13, adaptable to present the set of the one or more conditions comprises at least one of: time spent in each AIP learning scenario or in a session, response speed of the user or speed of the user in completing a task or an objective of each AIP learning scenario, number of attempts by the user to complete the task or the objective, absolute or relative correct answer score, demographics, location of the user, computing device of the user, connection speed of the user, or weather conditions of the location of the user.

15. The computer readable medium of claim 14, adaptable to present check comprising (1) a continuous check of the set of the one or more conditions, and (2) a full AIP assessment.

16. The computer readable medium of claim 12, configured to communicate with the processor, in response to the user passing the full AIP assessment, and configured to cause the user to exit the AIP learning.

17. The computer readable medium of claim 16, configured to receive the response to the user failing the full AIP assessment, and configured to redirect the user to (1) the at least one of the one or more variable AIP learning scenarios, or (2) one of the one or more levels of the AIP learning, wherein the processor, in response to the user passing the first AIP assessment, is configured to cause the user to exit the AIP learning.

18. A method of storing instructions that are executable by one or more processors to perform developing, via non-linear learning, a desired proficiency of a user in a topic, wherein a server is communicatively coupled to a network and including a processor, an adoptive information potential (AIP) module, a database containing portions allocated to at least congnigraphics data and non-cognigraphics data, and at least one non-transitory computer-readable storage medium having computer-readable instructions stored therein, the method comprising the steps of:
receiving input from the user based on a set of one or more questions prompted by the platform, the set of one or more questions comprising congnigraphics data and non-cognigraphics data;
constructing a user profile based on the congnigraphics and non-cognigraphics data;
storing the user profile in the database;
generating, based on the user profile, a first AIP recommendation for the user, the first AIP recommendation comprising a first set of one or more courses or training to be taken by the user based on the user profile;
executing a first AIP assessment of the user;
in response to the user not passing the first AIP assessment, executing a first level of one or more levels of AIP learning and display at least one of one or more variable AIP learning scenarios to the user, wherein the first level is selected according to the user profile including cognitive and non-cognitive attributes;
performing a continuous check and update of the user profile based on a set of one or more conditions;
in response to completion by the user the one or more variable AIP learning scenarios of the first level, providing to the user an exit scenario test;
advancing the user to a second level of the one or more levels of the AIP learning based on the exit scenario test; and
iteratively executing the one or more levels of the AIP learning to attain a desired proficiency of the user in the topic.

19. The method of claim 18, wherein in response to the user not passing the first AIP assessment, executing the first level of one or more levels of AIP learning and display at least one of one or more variable AIP learning scenarios each of the one or more variable AIP learning scenarios comprises logical chains of learning blocks positioned according to a learning pattern of the user, and wherein the one or more variable AIP learning scenarios are matched to one or more interests of the user corresponding to the topic.

20. The method of claim 19, presenting the learning blocks comprising at least one input block and one output block connected together.

21. The method of claim 20, presenting the learning blocks including an input content and an output content, wherein the input content includes text, audio, video, or images, and wherein the output items include interaction of the user with the input content.

22. The method of claim 21, presenting the set of the one or more conditions comprises at least one of: time spent in each AIP learning scenario or in a session, response speed of the user or speed of the user in completing a task or an objective of each AIP learning scenario, number of attempts by the user to complete the task or the objective, absolute or relative correct answer score, demographics, location of the user, computing device of the user, connection speed of the user, or weather conditions of the location of the user.

23. The method of claim 22, presenting check comprising (1) a continuous check of the set of the one or more conditions, and (2) a full AIP assessment.

24. The method of claim 23, communicating with the processor, in response to the user passing the full AIP assessment, and configured to cause the user to exit the AIP learning.

25. The method of claim 24, receiving the response to the user failing the full AIP assessment, and configured to redirect the user to (1) the at least one of the one or more variable AIP learning scenarios, or (2) one of the one or more levels of the AIP learning, wherein the processor, in response to the user passing the first AIP assessment, is configured to cause the user to exit the AIP learning.
